(19) United States
(12) Patent Application Publication
(10) Pub. No.: US 2023/0278784 A1
(43) Pub. Date: Sep. 7, 2023

(54) Wall Mount Waste Container

(71) Applicants: Nine Stars Group (USA) Inc., Ontario (CA); Fujian Nashida Electronic Incorporated Company, Fuzhou (CN)

(72) Inventors: Shiping WANG, Ontario, CA (US); Jiangqun CHEN, Fuzhou (CN); Youxi LUO, Fuzhou (CN); Xiujin YANG, Fuzhou (CN)

(21) Appl. No.: 17/748,157

(22) Filed: May 19, 2022

(30) Foreign Application Priority Data
Mar. 1, 2022 (CN) 202220422307.0

(51) Int. Cl. B65F 1/16

(52) U.S. Cl. CPC B65F 1/1646; B65F 2210/18

(57) ABSTRACT

A waste container includes a container body having a receiving cavity and a top opening, a lid and at least one connecting member. The lid has a size adapted for covering the top opening of the container body and one or more pivot joints provided on an inner side thereof. The at least one connecting member has a hinging end edge hinged to a top hinging edge of the container body and a pivoting end edge, parallel to the hinging end edge, pivotally mounted to the inner side of the lid through the one or more pivot joints of the lid so as to connect the lid with the container body. Thereby, the lid is capable of covering the top opening of the container body while the at least one connecting member is extended between the one or more pivot joints of the lid and the top hinging edge of the container body and an outer side of the connecting member is facing the receiving cavity of the container body. The lid is able to be flipped to parallelly hang down in front of an outer side of a container wall of the container body while the outer side of the connecting member is facing the inner side of the lid and an inner side of the connecting member is facing the outer side of the container wall of the container body.

### CROSS REFERENCE OF RELATED APPLICATION

This application is a non-provisional application that claims the benefit of priority under 35U.S.C.§119(e) to a Chinese application, application number 202220422307.0, filed Mar. 01, 2022, which is incorporated herewith by reference in its entirety.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### FIELD OF INVENTION

The present invention relates to a waste container, and more particularly to a wall mount waste container adapted to be mounted near the kitchen countertop with its lid configured to be pivotally opened and hung down in front of its container body for ease of disposing kitchen waste during food preparation.

### DESCRIPTION OF RELATED ARTS

During food preparation on the kitchen countertop, a small garbage bin is commonly placed on the countertop for food waste and other garbage produced. In order to provide more working area on the kitchen countertop, especially around the washing sink, as shown in FIG. 1, a hanging trash bin or bracket with a pair of hooks hanging to a top edge of a cabinet door wall is supported inside or outside of the cabinet door wall below the kitchen countertop. However, food waste discarded will rot quickly so that a lib is preferred to be provided to cover the trash bin. As shown in FIG. 2, a lid is provided to normally cover the trash can and comprises a hook configured for hanging on an edge of the bin body.

For ease of use, it is preferred the lid is connected to the bin body and configured to be moved between a cover state to cover the bin body and an open state to flip to a front side of the bin body. Please referring to FIG. 3A, a Chinese patent application number CN202011195335.5A discloses a hanging trash bin 1A comprises a bin body 11A having a top opening 12A, a slider member 13A, a lid 14A having a pair of guiding rails 141A provided on an inner side thereof, and a pair of hinges 15A hingedly connecting the slider member 13A with a top edge of the bin body 11A, wherein the lid 14A is configured to normally cover the top opening 12A of the bin body 11A and to allow the lid flipping to a side of the bin body 11A while the slider member 13A sliding between the pair of guiding rails 141A, as shown in FIG. 3B. The bin body 11A can be adhered to a back wall of the kitchen countertop or hanged to a cabinet door wall through a hook. However, the wet and sticky kitchen waste and food waste are easily stuck at the slider member 13A and the guiding rails 141A which are difficult to clean and wash thoroughly and adversely affect the sliding and flipping operation of the lid 14A.

Please referring to FIGS. 4A and 4B, a kitchen garbage can, PCT application number PCT/CN2020/078957, is disclosed, which does not have any sliding rails to avoid the kitchen waste and food waste stuck on the lid 2B. Instead, the can body 11B has a hook 5B adapted to hang on a cabinet door wall and a pair of hinging chambers 15B at two side walls 13B of the can body 11B. A pair of long rocker arms 31B and a pair of short arms 32B are equipped with the slide and linkage mechanism installed in the pair of hinge chambers 15B so as to allow the lid 2B to flip over to cover the bin body 11B or to flip down to a side of the can body 11B to open the can body 11B that the lid can be hanged down in front of the can body 11B. Although it removes the rails on the lid 2B, the slide and linkage mechanism is so complicated to assemble and costly and the chambers 15B are even more difficult to clean and wash. Kitchen waste may be stuck in the chambers 15B for long time causing sanitary problem. In addition, it is difficult to control the free swinging of the long rocker arms 31B and the degree of bending thereof, wherein when the lid 2B is flipped, it may lead to a large deflection and the stability and reliability of the operation are poor. The formation of the hinging chambers 15B and the installation of the rocker arms 31B and slide and linkage mechanism in the hinging chamber 15B occupy much space that reduces the storing volume of the can body 11B and increase the total weight of the trash bin at the same time.

A lid hangable trash bin with no cleaning difficulty and without complicate configuration is highly demanded by the consumers. It is preferred to be cost effective and can be easily assembled and disassembled for cleaning and washing thoroughly.

### SUMMARY OF THE PRESENT INVENTION

The invention is advantageous in that it provides a wall mount waste container which cover lid can be flipped up to cover the container body and flipped down to hang on a side of the container body to open the container body simply by means of a single connecting member without complicate mechanism or formation of any rail or chamber which is difficult to be clean and wash.

Another advantage of the invention is to provide a wall mount waste container which is easily to be assembled and dissembled for cleaning and washing thoroughly.

Another advantage of the invention is to provide a wall mount waste container which minimizes the number of components and production cost and has a light weight.

Another advantage of the invention is to provide a wall mount waste container which is easy to open by slightly pulling down its cover lid and to close by slightly pushing up its cover lid.

Another advantage of the invention is to provide a connecting member for connecting a cover lid with a container body of a wall mount waste container which enables the lid to be slowly flipping down lightly due to gravity while preventing the lid from heavily dropping down due to its weight.

According to the present invention, the foregoing and other objects and advantages are attained by a waste container, comprising:
a container body having a receiving cavity and a top opening;
a lid having a size adapted for covering the top opening of the container body and one or more pivot joints provided on an inner side thereof; and
at least one connecting member having a hinging end edge hinged to a top hinging edge of the container body and a pivoting end edge, parallel to the hinging end edge, pivotally mounted to the inner side of the lid through the one or more pivot joints of the lid so as to connect the lid with the container body in such a manner that the lid is capable of covering the top opening of the container body while the at least one connecting member is extended between the one or more pivot joints of the lid and the top hinging edge of the container body and an outer side of the connecting member is facing the receiving cavity of the container body, and that the lid is able to be flipped to parallelly hang down in front of an outer side of a container wall of the container body while the outer side of the connecting member is facing the inner side of the lid and an inner side of the connecting member is facing the outer side of the container wall of the container body.

In one embodiment, the at least one connecting member is a leaflet connecting member having a predetermined width, wherein a distance between the one or more pivot joints and at least one edge of the lid is at least equal to the predetermined width of the leaflet connecting member.

In one embodiment, two or more connecting members each having a hinging end edge pivotally connected to a hinge bar which is hinged to the top hinging edge of the container body and a pivoting end edge pivotally connected to the respective pivot joint of the lid.

In one embodiment, at least one connecting member is hingedly rotatable about the top hinging edge of the container body such that the at least one connecting member is able to gradually flip between the receiving cavity of the container body and outside the container wall, such that the lid, which is pivotally connected to the connecting member through the one or more pivot joints, is able to flip up to cover the top opening of the container body by rotating the at least one connecting member to a position above the top opening, and that the lid is able to flip down to a vertical position outside the container wall having the top edge hinged with the at least one connecting member while the at least connecting member substantially supporting and hanging the lid downwards to be generally parallel to the container wall.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view illustrating a conventional trash bin hanged to a cabinet door wall.

FIG. 2 is a schematic view illustrating a conventional trash bin hanged to a cabinet door wall with a lid hooked to a handle thereof.

FIG. 3A is a perspective view of a conventional hanging trash bin.

FIG. 3B is schematic view illustrating the operation of closing and opening of the lid with the bin body of the conventional hanging trash bin as shown in FIG. 3A.

FIG. 4A is a perspective view of a conventional kitchen garbage can.

FIG. 4B is a partially sectional view of the conventional kitchen garbage can as shown in FIG. 4A.

FIG. 5 is a perspective of a waste container according to a preferred embodiment of the present invention.

FIG. 6 is an exploded perspective view of the waste container according to the above preferred embodiment of the present invention.

FIG. 7 is a perspective view of a connecting member of the waste container according to the above preferred embodiment of the present invention.

FIG. 8 is a perspective view illustrating an opening operation of the waste container the waste container according to the above preferred embodiment of the present invention.

FIG. 9 is a perspective view of the waste container in half-open condition according to the above preferred embodiment of the present invention.

FIG. 10 is a perspective view of the waste container in flipping condition according to the above preferred embodiment of the present invention.

FIG. 11 is perspective view of the waste container in open condition according to the above preferred embodiment of the present invention.

FIG. 12A is a sectional view of the lid of the waster container in open condition with the container body according to the above preferred embodiment of the present invention.

FIG. 12B is a sectional view of the lid of the waste container in close condition with the container body according to the above preferred embodiment of the present invention.

FIG. 13 is an exploded view of an alternative mode of the waste container according to the above preferred embodiment of the present invention.

FIG. 14 is a perspective view of the connecting member of the alternative mode of the waste container according to the above preferred embodiment of the present invention.

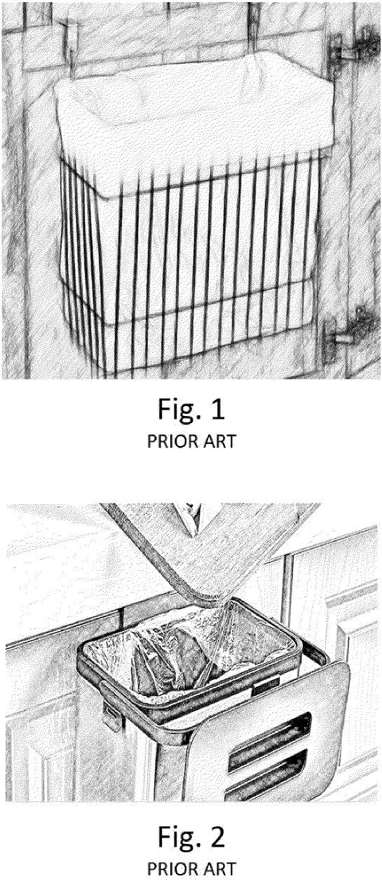

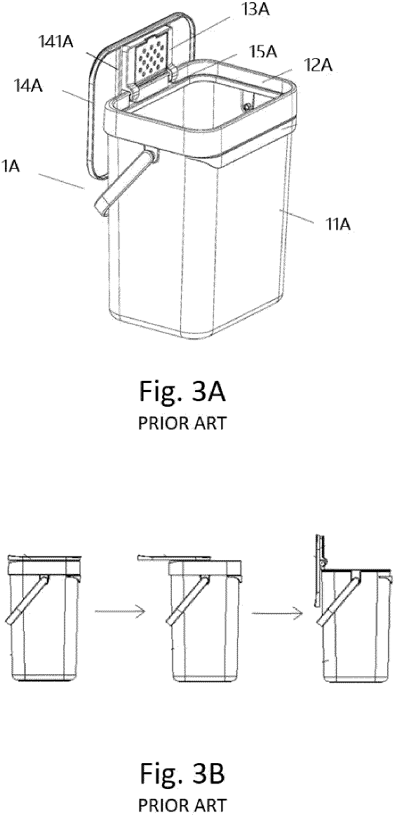

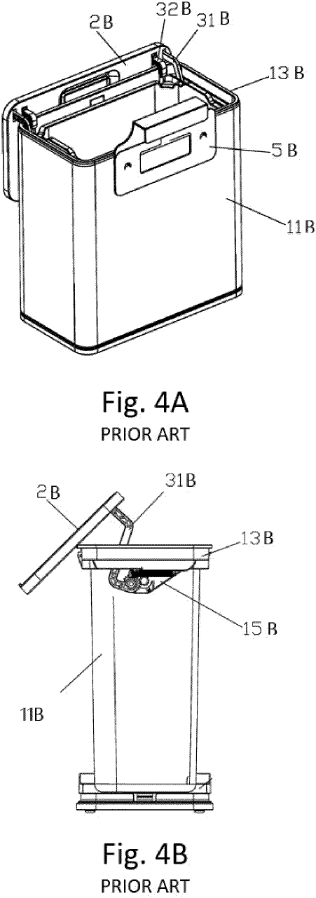

The drawings, described above, are provided for purposes of illustration, and not of limitation, of the aspects and features of various examples of embodiments of the invention described herein. The drawings are not intended to limit the scope of the claimed invention in any aspect. For simplicity and clarity of illustration, elements shown in the drawings have not necessarily been drawn to scale and the dimensions of some of the elements may be exaggerated relative to other elements for clarity.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

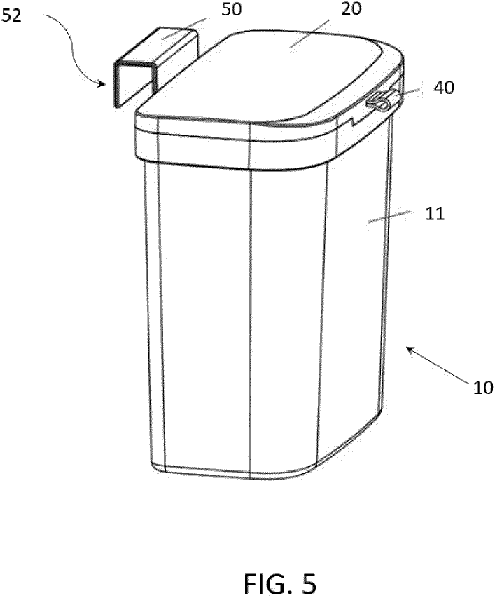

Referring to FIGS. 5 to 12, a wall mount waste container 10 according to a preferred embodiment of the present invention is illustrated. The waste container 10 comprises a container body 11 having a receiving cavity 111 therein and a top opening 112, a lid 20 having a size and configuration adapted for covering the top opening 111 of the container body 11, and at least one connecting member 30 configured to connect the lid 20 with the container body 11.

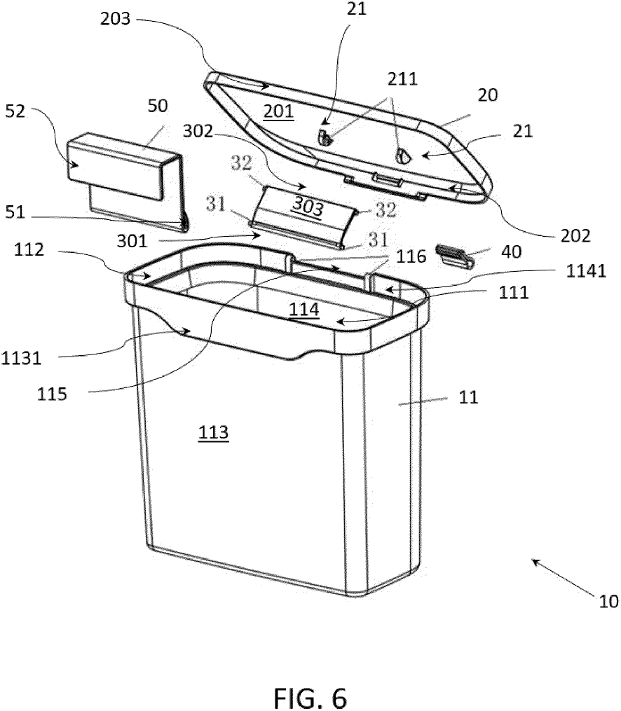

Referring to FIG. 6, the container body 11 can be any shape such as circular, rectangular, square, and etc. having a mounting lip 1131 and a hinging edge 1141 at upper portions of a rear and a front container walls 113, 114 respectively.

The lid 20 further comprises one or more pivot joints 21 provided on an inner side 201 thereof. According to the preferred embodiment, referring to FIG. 6, a pair of pivot joints 21 is integrally protruded from the inner side 201 of the lid 20, wherein an axis between the two pivot joints 21 is preferred to be generally aligned in parallel with a front edge 202 and a rear edge 203 of the lid 20. The pair of pivot joints 21 each having a pivot hole 211 is arranged in opposing positions that the two pivot holes 211 are coaxially facing each other, defining a first distance between the axis of the pair of pivot joints 21 and the front edge 202 and a second distance between the axis of the pair of pivot joints 21 and the rear edge 203 of the lid 20, wherein both said first and second distances are bigger than a width of the connecting member 30.

Referring to FIGS. 6-8 and 12, the at least one connecting member 30 has a hinging end edge 301 hinged to the hinging edge 1141 of the container body 11 and a pivoting end edge 302, parallel to the hinging end edge 301, pivotally mounted between the pair of pivot joints 21 of the lid 20 so as to connect the lid 20 with the container body 11 in such a manner that the lid 20 is capable of covering the top opening 112 of the container body 11 while the at least one connecting member 30 is extended between the pair of pivot joints 21 of the lid 20 and the top hinging edge 1141 of the container body 11 and an outer side 303 of the connecting member 30 is facing the receiving cavity 111 of the container body 11, and that the lid 20 is able to be flipped to parallelly hang down to an outer side of the container wall 114 of the container body 11 while the outer side 303 of the connecting member 30 is facing the inner side 201 of the lid 20 and an inner side 304 of the connecting member 30 is facing the outer side of the container wall 114 of the container body 11.

According to the preferred embodiment, the connecting member 30 is embodied as a leaflet connecting member 30 which has a predetermined width generally equal to or slightly smaller than the first distance between the axis of the pair of pivot joints 21 and the front edge 202 of the lid 20. The leaflet connecting member 30 has a hinge leaflet portion 305 extended away from the inner side 304 along the hinging end edge 301 to form a L-shape cross section. The leaflet connecting member 30 comprises a hinge axle 31 provided at the hinge leaflet portion 305 and a pair of pivot axles 32 outwardly and opposingly extended from two ends of the at the pivoting end edge 302 thereof defining a pivot axis therebetween.

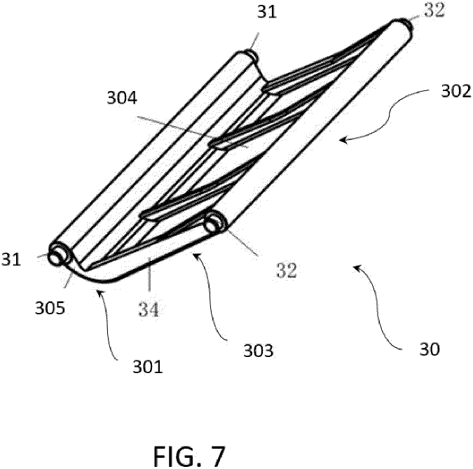

In one embodiment, as shown in FIG. 7, the leaflet connecting member 30 is made of plastic by molding, wherein a plurality of reinforcing ribs 306 is form on the inner side 304 to reinforce the configuration so that the leaflet connecting member 30 can be made to have a thinner thickness and lighter weight.

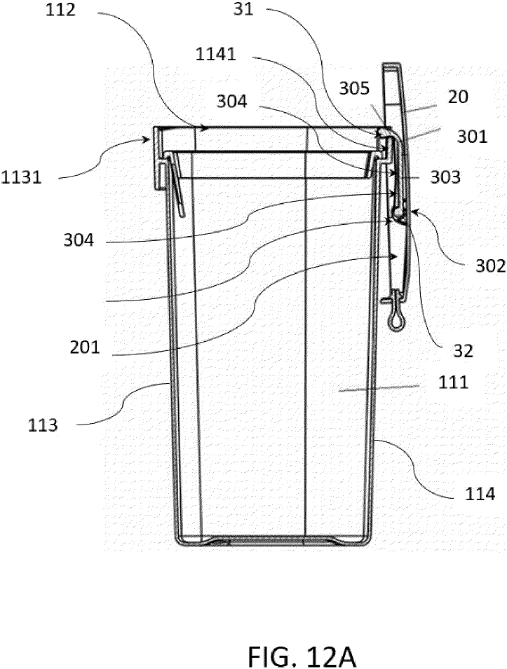

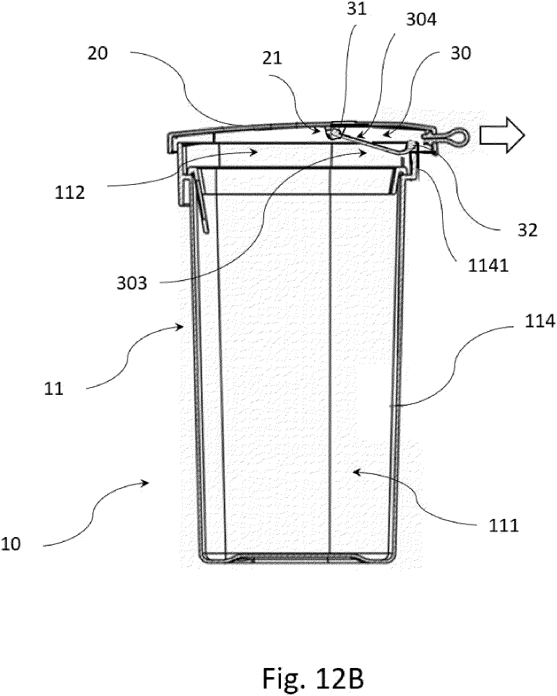

As shown in FIGS. 6 and 7, the top hinging edge 1141 of the container body 11 has a hinge slot 115 and a pair of hinging holes 116, wherein a length and a depth of the hinge slot 115 is preferred to be equal to or slightly larger than a length and a thickness of the leaflet connecting member 30 respectively, such that the hinge leaflet portion 305 is adapted to be pivotally mounted in the hinge slot 115 with the two ends of the hinge axle 31 rotatably inserted into the two hinging holes 116 respectively so as to hinge the leaflet connecting member 30 with the container body 11, so that the leaflet connecting member 30 can be rotated about the hinge axle 31 between positions from the top opening 112 above the receiving cavity 111 as shown in FIG. 12B and the outer side of the container wall 114 where the leaflet connecting member 30 hinged thereto as shown in FIG. 12A.

To assemble the lid 20 with the container body 11, simply pivotally insert the two pivot axles 32 of the leaflet connecting member 30 into the two pivot holes 211 of the two pivot joints 21 respectively, referring to FIGS. 6, 12A and 12B, such that the lid 20 is pivotally connected with the container body 11 through the leaflet connecting member 30, wherein the lid 20 is able to be moved between an open condition as shown in FIG. 12A and a close condition as shown in FIG. 12B.

In the close condition, as shown in FIG. 12B, the lid 20 is flipped up to cover the top opening 112 of the container body 11 to enclose the receiving cavity 111 of the container body 11, wherein the connecting member 30 is extended between the hinging edge 1141 of the container body 11 and the pair of pivot joints 21 while the outer side 303 of the connecting member 30 is facing towards the receiving cavity 111 of the container body 11 and the inner side 304 of the connecting member 30 is facing the lib 20. It is appreciated that the L-shape leaflet connecting member 30 significantly avoids any contact and conflict with the lid 20 while the flipping of the lib 20 driven by the pivotally swinging of the leaflet connecting member 30.

To facilitate the opening operation of the lid 20, the waste container 10 may further comprises a handle 40 to the front edge 202 of the lid 20.

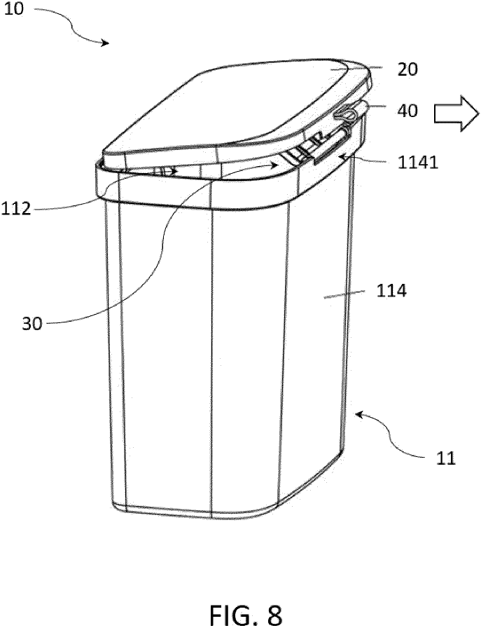

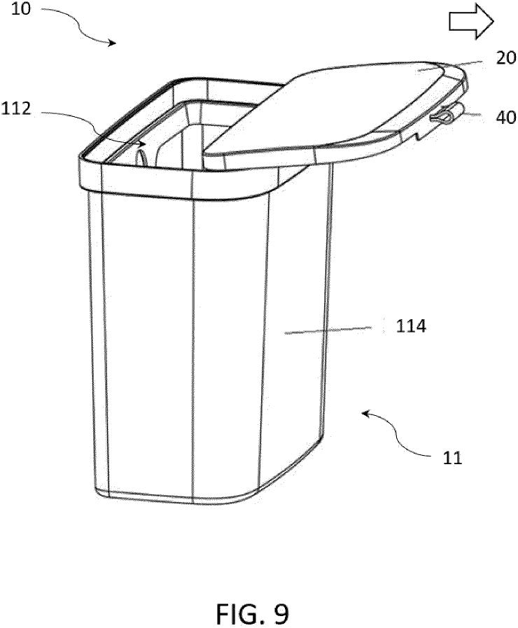

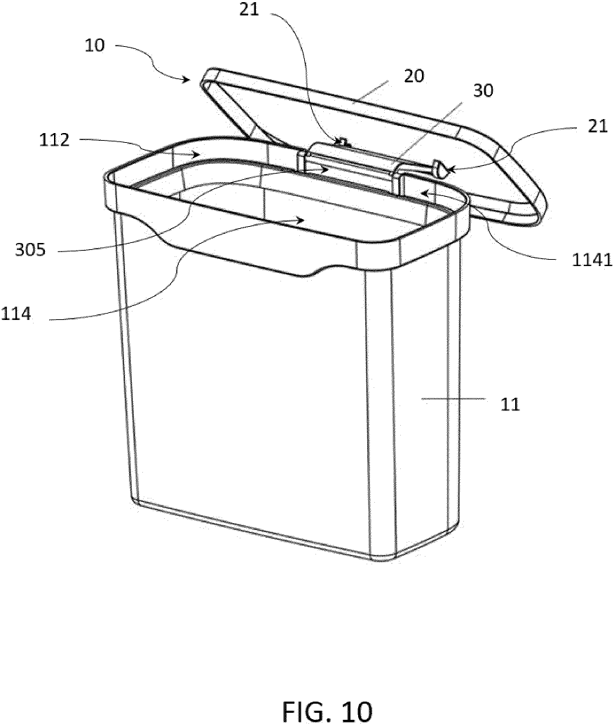

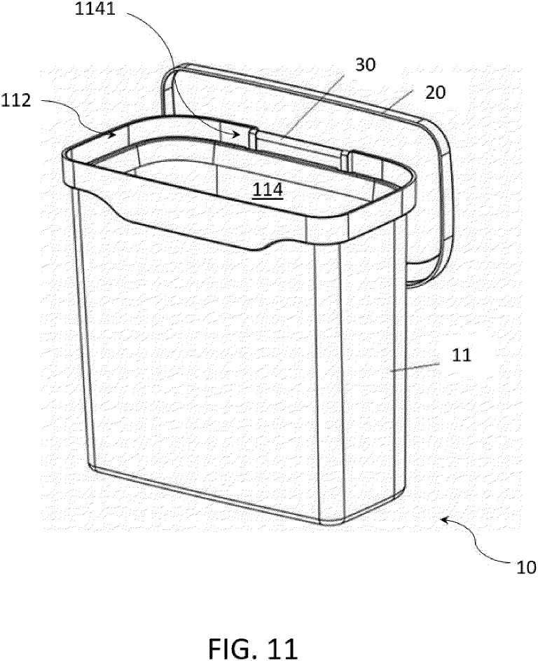

To open the waste container 10, applying uplifting and/or horizontal puling force to the lib 20, as shown in FIGS. 8 and 12B, or simply pushing the lib or the handle 40 frontwardly, the frontwardly moving lid 20 drives the connecting member 30 to pivotally rotate about the hinge axle 31 and flip to a position outside the container body 11 as shown in FIGS. 9 and 10. Due to gravity, the weight of the lid 20 drives the lid 20 to fall down along the container wall 114 of the container body 11 until the lid 20 is flipped down and hanged by the connecting member 30 to the open condition that the lid 20 is parallelly hanged down to the outer side of the container wall 114 while the outer side 303 of the connecting member 30 is facing the inner side of the lid 20 and the inner side 304 of the connecting member 30 is facing the outer side of the container wall 114 of the container body 11, as shown in FIGS. 11 and 12A. It is appreciated that the friction arranged between the hinge axle 31 and the hinging hole 116 of the top hinging edge 1141 of the container wall 114 of the container body 11 and the L-shaped configuration of the leaflet connecting member 30 significantly buffers the lid 20 to slowly hang and drop down to the open condition thereof.

In other words, the connecting member 30 is hingedly rotatable about the top hinging edge 1141 of the container body 11 such that the connecting member 30 is able to gradually flip between the receiving cavity 111 of the container body 11 and outside the container wall 114, such that the lid 20, which is pivotally connected to the connecting member 30 through the one or more pivot joints 21, is able to flip up to cover the top opening 112 of the container body 11 by rotating the connecting member 30 to a position above the top opening 112, and that the lid 20 is able to flip down to a vertical position outside the container wall 114 having the top edge hinged with the connecting member 30 while the at least connecting member 30 substantially supporting and hanging the lid 20 downwards to be generally parallel to the container wall 114.

To close the waster container 10, simply flipping the lib 20 up over the top opening 112 to rest on top of the container body 11, the container body 11 is covered by the lid 20 as shown in FIGS. 5 and 12B.

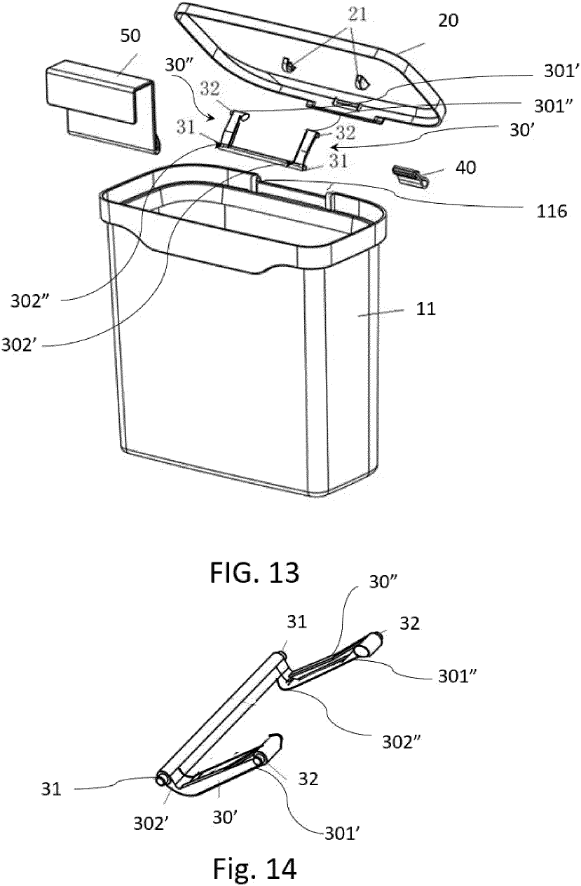

Referring to FIGS. 13 and 14, an alternative mode of the connecting member 30 is illustrated to be implemented with container body 11 and the lid 20 to form the waste container 10, wherein the at least one connecting member 30 is embodied to have two connecting members 30′, 30″ each having a L-shape elongated arm. Each of the connecting members 30′, 30″ has a hinging end edge 301′, 301″ connected to a hinge axle 31 which is hinged to the top hinging edge 1141 of the container body 11 and a pivot axle 32 provided at the pivoting end edge 302′, 302″ for pivotally connecting to the respective pivot joint 21 of the lid 20. Such alternative mode is functioned similarly to the preferred embodiment described above.

The waste container 10 of the present invention can be mounted to a wall adjacent to the kitchen countertop or a wall of the cabinet. In order to hang the waster container 10 to a cabinet door wall (not shown), the waste container further comprises a hanger hook 50, as shown in FIGS. 6 and 7, which has an engaging edge 51 engaged to the mounting edge 1131 provided on the rear container wall 113 and a hook 52 configured to hook and hang to a top edge of the cabinet door wall.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A waste container, comprising:
a container body having a receiving cavity therein and a top opening;
a lid having a size adapted for covering said top opening of said container body and comprising one or more pivot joints provided on an inner side thereof; and
at least one connecting member having a hinging end edge hinged to a top hinging edge of said container body and a pivoting end edge, parallel to said hinging end edge, pivotally mounted to said inner side of said lid through said one or more pivot joints of said lid so as to connect said lid with said container body in such a manner that said lid is capable of covering said top opening of said container body while said at least one connecting member is extended between said one or more pivot joints of said lid and said top hinging edge of said container body and an outer side of said at least one connecting member is facing said receiving cavity of said container body, and that said lid is able to be flipped to hang down in front of an outer side of a first container wall of said container body while said outer side of said at least one connecting member is facing said inner side of said lid and an inner side of said at least one connecting member is facing said outer side of said first container wall of said container body.

2. The waste container, as recited in claim 1, wherein said top hinging edge of said container body has a hinge slot configured to be hinged with said hinging end edge of said at least one connecting member.

3. The waste container, as recited in claim 2, wherein said at least one connecting member further comprises a hinge axle extended along said hinging end edge thereof, and two ends of said hinge slot respectively have a pair of hinge holes formed coaxially, wherein two ends of said hinge axle are rotatably inserted into the pair of hinge holes respectively so as to hinge said connecting member with said container body, such that said connecting member is able to be rotated about said hinge axle between positions from said top opening above said receiving cavity and said outer side of said first container wall.

4. The waste container, as recited in claim 1, wherein said lid comprises a pair of pivot j oints of said one or more pivot j oints internally protruded from said inner side of said lid, wherein each of said pair of pivot joints has a pivot hole opposing with each other coaxially, and that said at least one connecting member comprises two pivot axles at said pivoting end edge configured to be rotatably inserted in said two pivot holes of said pair points respectively so as to pivotally connected said at least one connecting member between said pair of pivot joints of said lid, wherein a first distance between said pair of pivot joints and an front edge of said lid and a second distance between said pair of pivot joints and an rear edge of said lid are bigger than a width of said at least one connecting member.

5. The waste container, as recited in claim 2, wherein said lid comprises a pair of pivot j oints of said one or more pivot j oints internally protruded from said inner side of said lid, wherein each of said pair of pivot joints has a pivot hole opposing with each other coaxially, and that said at least one connecting member comprises two pivot axles at said pivoting end edge configured to be rotatably inserted in said two pivot holes of said pair points respectively so as to pivotally connected said at least one connecting member between said pair of pivot joints of said lid, wherein a first distance between said pair of pivot joints and an front edge of said lid and a second distance between said pair of pivot joints and an rear edge of said lid are bigger than a width of said at least one connecting member.

6. The waste container, as recited in claim 3, wherein said lid comprises a pair of pivot j oints of said one or more pivot j oints internally protruded from said inner side of said lid, wherein each of said pair of pivot joints has a pivot hole opposing with each other coaxially, and that said at least one connecting member comprises two pivot axles at said pivoting end edge configured to be rotatably inserted in said two pivot holes of said pair points respectively so as to pivotally connected said at least one connecting member between said pair of pivot joints of said lid, wherein a first distance between said pair of pivot joints and an front edge of said lid and a second distance between said pair of pivot joints and an rear edge of said lid are bigger than a width of said at least one connecting member.

7. The waste container, as recited in claim 1, wherein said at least one connecting member comprises a leaflet connecting member, which comprises a hinge leaflet portion extended away from an inner side thereof along said hinging end edge to form a L-shape cross section, and a hinge axle provided at said hinge leaflet portion for hinging with said top hinging edge of said container body.

8. The waste container, as recited in claim 2, wherein said at least one connecting member comprises a leaflet connecting member, which comprises a hinge leaflet portion extended away from an inner side thereof along said hinging end edge to form a L-shape cross section, and a hinge axle provided at said hinge leaflet portion for being hinged in said hinge slot formed at said top hinging edge of said container body.

9. The waste container, as recited in claim 3, wherein said at least one connecting member comprises a leaflet connecting member, which comprises a hinge leaflet portion extended away from an inner side thereof along said hinging end edge to form a L-shape cross section.

10. The waste container, as recited in claim 4, wherein said at least one connecting member comprises a leaflet connecting member, which comprises a hinge leaflet portion extended away from an inner side thereof along said hinging end edge to form a L-shape cross section, and a hinge axle provided at said hinge leaflet portion for hinging with said top hinging edge of said container body.

11. The waste container, as recited in claim 5, wherein said at least one connecting member comprises a leaflet connecting member, which comprises a hinge leaflet portion extended away from an inner side thereof along said hinging end edge to form a L-shape cross section, and a hinge axle provided at said hinge leaflet portion for being hinged in said hinge slot formed at said top hinging edge of said container body.

12. The waste container, as recited in claim 6, wherein said at least one connecting member comprises a leaflet connecting member, which comprises a hinge leaflet portion extended away from an inner side thereof along said hinging end edge to form a L-shape cross section.

13. The waste container, as recited in claim 1, further comprising a handle provided at a front edge of said lid allowing pulling force applied thereto to move said lid to drive said at least one connecting member to pivotally rotate about said top hinging edge of said container body and flip to a position outside said container body.

14. The waste container, as recited in claim 3, further comprising a handle provided at a front edge of said lid allowing pulling force applied thereto to move said lid to drive said at least one connecting member to pivotally rotate about said hinge axle and flip to a position outside said container body.

15. A method of operating a waste container, comprising steps of:
(a) pivotally connecting a lid with a pivoting end edge of at least one connecting member while a hinging end edge of said at least one connecting member is hinged with a top hinging edge of a container body;
(b) enclosing a receiving cavity of said container body and covering a top opening of said container body by said lid while said at least one connecting member is extended between one or more pivot joints provided on an inner side of said lid and said hinging end edge of said container body; and
(c) opening said top opening of said container body by moving said lid frontwards to drive said at least one connecting member to pivotally rotate about said hinging end edge of said container body to a position outside said container body, wherein a weight of said lid drives said lid to fall down along a front container wall of said container body until said lid is flipped down and hanged by said at least one connecting member.

16. The method, as recited in claim 15, wherein in the step (b), an outer side of said at least one connecting member is facing said receiving cavity of said container body and an inner side of said at least one connecting member is facing said lid.

17. The method, as recited in claim 15, wherein in the step (c), an outer side of said at least one connecting member is facing an inner side of said lid and an inner side of said at least one connecting member is facing an outer side of said front container wall of said container body.

18. The method, as recited in claim 16, wherein in the step (c), said outer side of said at least one connecting member is facing an inner side of said lid and said inner side of said at least one connecting member is facing an outer side of said front container wall of said container body.

19. The method, as recited in claim 15, wherein in the step (a), pivotally inserting a pair of pivot axles into a pair of pivot joints provided on an inner side of said lid respectively.

20. The method, as recited in claim 18, wherein in the step (a), pivotally inserting a pair of pivot axles into a pair of pivot j oints provided on said inner side of said lid respectively.
